(19) United States
(12) Patent Application Publication
(10) Pub. No.: US 2009/0128859 A1
(43) Pub. Date: May 21, 2009

(54) SYSTEM AND METHOD FOR GENERATING WATERMARKS ON ELECTRONIC DOCUMENTS

(76) Inventors: Brenda DAOS, Mission Viejo, CA (US); Marianne L. Kodimer, Huntington Beach, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/944,129

(22) Filed: Nov. 21, 2007

(51) Int. Cl. G06K 15/00

(52) U.S. Cl. 358/3.28

(57) ABSTRACT

The subject application is directed to a system and method for document watermarking. First, electronic document data is received into a memory associated with a document processing device. A page image is then generated from the electronic document data on a touchscreen user interface panel associated with the document processing device. A signature area is then generated on the touchscreen and positioned relative to a selected portion of the page image via the dragging of the signature area to a selected portion of the page image. Signature image data is then received and an image corresponding to the received signature image data is superimposed on the positioned signature area. A composite document output is thereafter generated of the electronic document data and the signature image data, with the signature image formed in the positioned signature area.

### BACKGROUND OF THE INVENTION

The subject application is directed generally to finishing of electronic documents by applications of watermarks via document processing devices. The subject application is particularly applicable to adding a signature image to electronic documents via a touchscreen control interface.

Document processing devices in widespread use today include copiers, printers, facsimile machines and scanners, as well as devices, referred to as multifunction peripherals or MFPs, which accomplish two or more of these functions.

Documents are more frequently being exchanged electronically, or are generated entirely from electronic data. Certain aspects of documents still require some degree of customization, such as with selection or placement of watermarks, such as with an addition of a signature image. By way of example, users may create a digital file with an encoded image of their signature. A user can, while working on their workstation, import a signature image file and position it on a document, such that an electronic document is formed which, when printed or displayed, appears to be a signed document, such as a signed contract or a signed letter.

Alternatively, a user can print a document from an application, such as a word processing application, sign the hard copy, and scan the signed document into an image file.

When a user wishes to create a watermarked document, such as a signed electronic document, the alternatives noted above require a substantial number of steps or the use of a workstation. There is a substantial loss of efficiency, particularly when a watermark is desired for a document that is being processed at a remote, shared document processing device.

### SUMMARY OF THE INVENTION

In accordance with one embodiment of the subject application, there is provided a system and method for finishing of electronic documents by application of watermarks via document processing devices.

Further, in accordance with one embodiment of the subject application, there is provided a system and method for adding a signature image to electronic documents via a touchscreen control interface.

Still further, in accordance with one embodiment of the subject application, there is provided a system for document watermarking. The system comprises means adapted for receiving electronic document data into a memory associated with an associated document processing device and means adapted for generating a page image of the electronic document data on a touchscreen user interface panel associated with the document processing device. The system also comprises means adapted for generating a signature area on the touchscreen user interface and means adapted for positioning the signature area relative to a selected portion of the page image in accordance with interaction with the touchscreen by dragging the signature area. The system further comprises means adapted for receiving signature image data corresponding to a signature image and means adapted for superimposing an image corresponding to received signature image data on a positioned signature area on the touchscreen user interface. The system also includes means adapted for generating a composite document output inclusive of the electronic document data and the signature image data wherein the signature image is formed in the positioned signature area.

In one embodiment of the subject application, the system also comprises means adapted for altering a size of the signature portion in accordance with interaction with the touchscreen by dragging an edge thereof and means adapted for adjusting a size of the received signature image in accordance with an area of the signature area. Preferably, the system also comprises means adapted for generating a grid image so as to be superimposed on the page image so as to assist in positioning of the signature area via the touchscreen interface.

In another embodiment of the subject application, the signature area is rectangular and further comprising means adapted for maintaining relative orientation of the signature area and an edge of the generated page image during positioning thereof.

In yet another embodiment of the subject application, the system also comprises means adapted for receiving magnification level selection data via the touchscreen user interface and means adapted for selectively generating a zoom image of the page image on the touchscreen user interface in accordance with received magnification level selection data.

Still further, in accordance with one embodiment of the subject application, there is provided a method for document watermarking in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for document watermarking according to one embodiment of the subject application;

FIG. 2 is a block diagram illustrating device hardware for use in the system for document watermarking according to one embodiment of the subject application;

FIG. 3 is a functional diagram illustrating the device for use in the system for document watermarking according to one embodiment of the subject application;

FIG. 4 is a block diagram illustrating controller hardware for use in the system for document watermarking according to one embodiment of the subject application;

FIG. 5 is a functional diagram illustrating the controller for use in the system for document watermarking according to one embodiment of the subject application;

FIG. 6 is a flowchart illustrating a method for document watermarking according to one embodiment of the subject application;

FIG. 7 is a flowchart illustrating a method for document watermarking according to one embodiment of the subject application;

FIG. 8 is an example illustrating a touchscreen interface for use in the system and method for document watermarking according to one embodiment of the subject application;

FIG. 9 is a further example illustrating a touchscreen interface for use in the system and method for document watermarking according to one embodiment of the subject application;

FIG. 10 is another example illustrating a touchscreen interface for use in the system and method for document watermarking according to one embodiment of the subject application; and

FIG. 11 is an example illustrating a touchscreen interface for use in the system and method for document watermarking according to one embodiment of the subject application;

### DETAILED DESCRIPTION OF THE PREFERRED EMBODIMENT

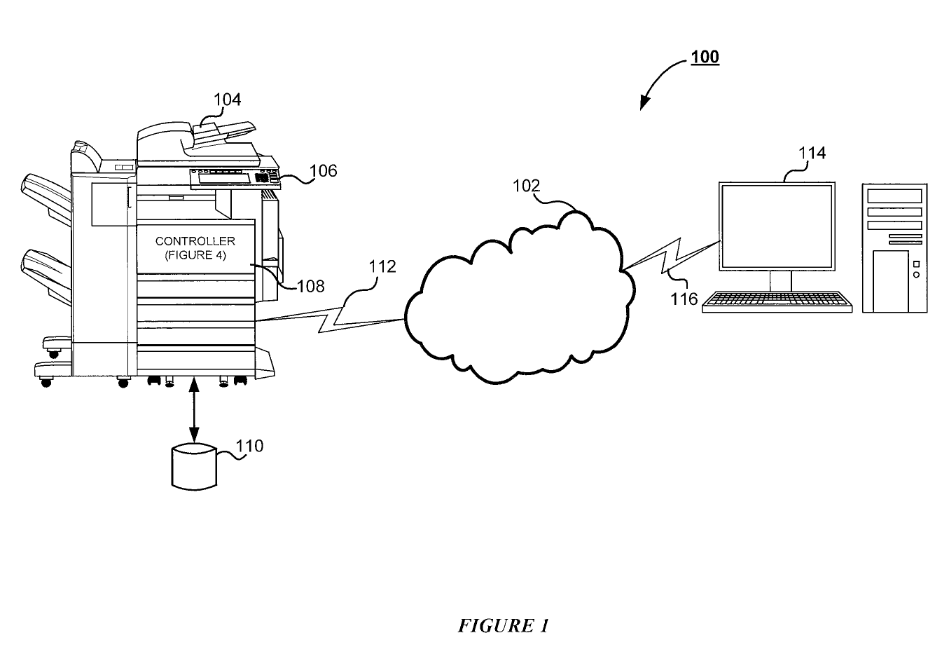

The subject application is directed generally to a system and method for finishing of electronic documents by application of watermarks via document processing devices. In particular, the subject application is directed to a system and method for adding a signature image to electronic documents via a touchscreen control interface. More particularly, the subject application is directed to a system and method that allows a user to insert watermarks into a document via a touchscreen interface at a document processing device. It will become apparent to those skilled in the art that the system and method described herein are suitably adapted to a plurality of varying electronic fields employing graphical user interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for document watermarking in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

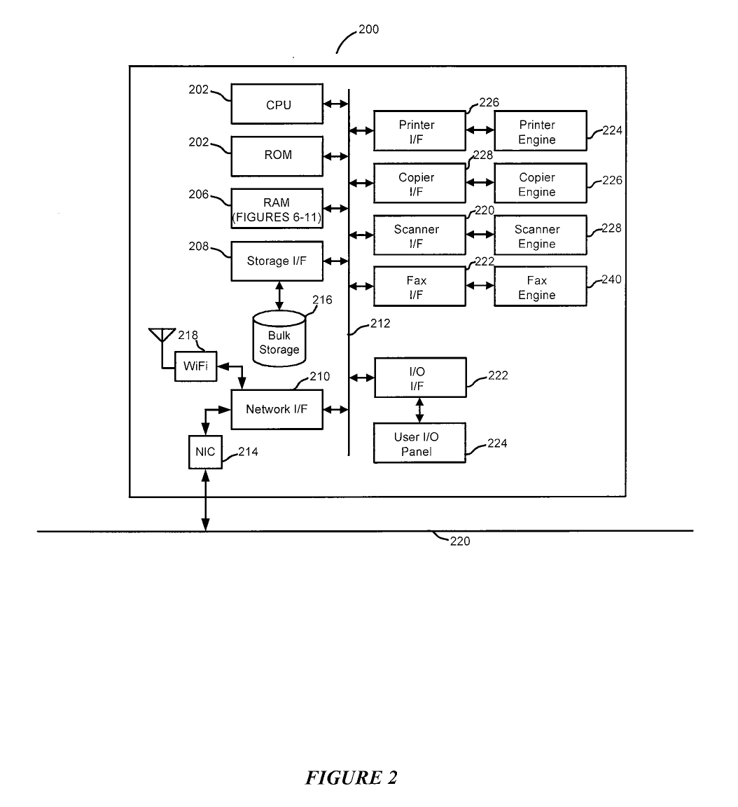

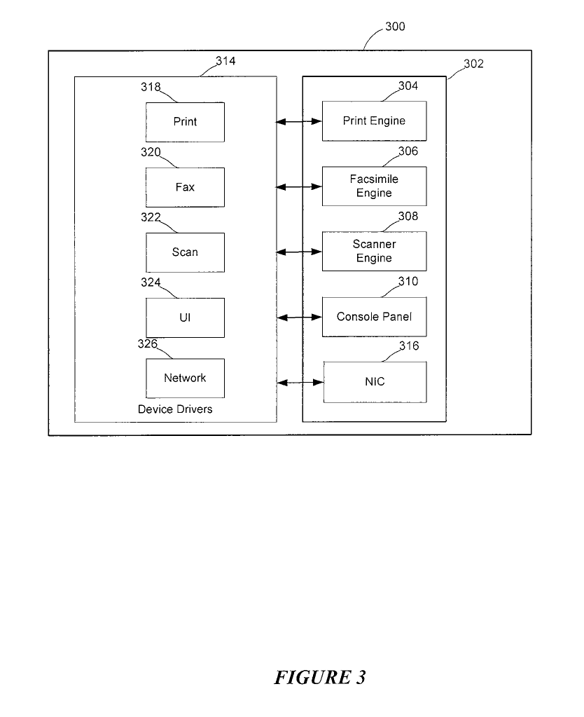

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the document processing device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

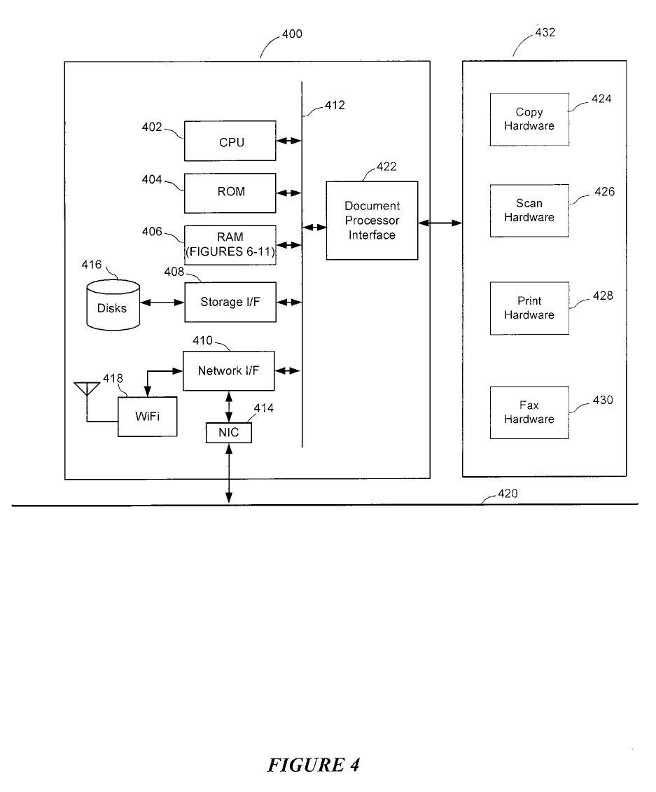

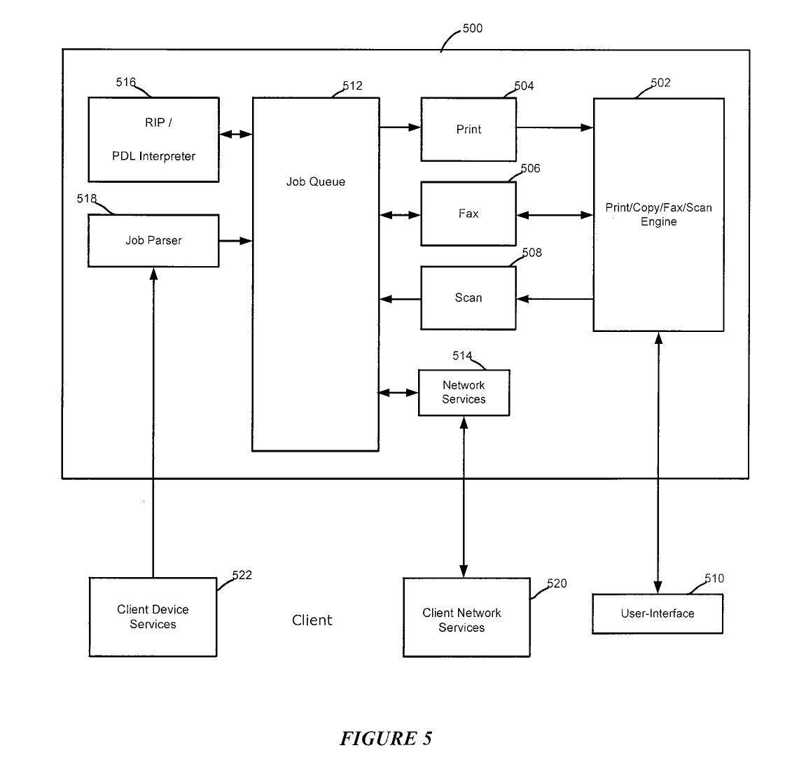

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for document watermarking of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, user identification data, watermark image data, signature image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

Turning now to FIG. 2, illustrated is a representative architecture of a suitable device 200, (shown in FIG. 1 as the document processing device 104), on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, (shown in FIG. 1 as the document processing device 104), for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that the processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which include the controller 400 of FIG. 4, (shown in FIG. 1 as the controller 108) as an intelligent subsystem associated with a document processing device. In the illustration of FIG. 5, controller function 500 in the preferred embodiment, includes a document processing engine 502. A suitable controller functionality is that incorporated into the Toshiba c-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a job parser 518, which job parser suitably functions to receive print job language files from an external device, such as client device services 522. The client device services 522 suitably include printing, facsimile transmission, or other suitable input of an electronic document for which handling by the controller function 500 is advantageous. The job parser 518 functions to interpret a received electronic document file and relay it to the job queue 512 for handling in connection with the afore-described functionality and components.

In operation, electronic document data is received into a memory associated with an associated document processing device. A page image is then generated of the electronic document data on a touchscreen user interface panel associated with the document processing device. A signature area is then generated on the touchscreen user interface and is positioned relative to a selected portion of the page image in accordance with interaction with the touchscreen. Preferably, such interaction corresponds to the dragging of the signature area to a selected portion of the page image. Signature image data is then received corresponding to a signature image. An image corresponding to the received signature image data is then superimposed on a positioned signature area on the touchscreen user interface. A composite document output is then generated inclusive of the electronic document data and the signature image data, with the signature image being formed in the positioned signature area.

In accordance with one example embodiment of the subject application, a user, via the user interface 106 associated with the document processing device 104, inputs user identification data, e.g. a username/password, biometric data, or the like. Preferably, the document processing device 104, via the data storage device 110, stores identification data associated with a plurality of users of the document processing device 104. A document processing request is then received from the associated user via interactions with the user interface 106 associated with the document processing device 104. It will be appreciated by those skilled in the art that such a document processing request includes at least one electronic document for processing by the associated document processing device 104. The skilled artisan will further appreciate that such request is capable of being communicated from the user device 114 to the document processing device 104 via the computer network 102, e.g. a private print request requiring user authentication at the document processing device 104 prior to the processing thereof.

Page image data corresponding to the received electronic document is then generated via the display of the user interface 106 associated with the document processing device 104. Preferably, the page image data corresponds to a graphical representation, e.g. thumbnail, preview, etc., of the received electronic document displayed via a graphical user interface on the user interface 106. Upon selection by the user of the addition of a digital signature, e.g. a selected option available via the document processing device 104, the controller 110 or other suitable component associated with the document processing device 104 receives signature image data corresponding to a signature associated with the user. In accordance with one embodiment of the subject application, the signature image data is received from the associated data storage 110 corresponding to the received user identification data. In such an embodiment, the data storage device 110 includes a plurality of signature images associated with a corresponding plurality of users, each of which is accessible by the associated user, for example, watermark signatures. In accordance with a further embodiment of the subject application, signature image data is received from the associated user via interaction with the user interface 106, such as use of a stylus on the touchscreen panel, from an associated portable storage medium, via output of a scanning operation, from the user device 114 via the computer network 102, or the like. It will be appreciated by those skilled in the art that when a digital signature is not desired to be added to the received electronic document, the document processing device 104 performs the requested document processing operation on the document in accordance with the received request.

A grid image is then generated and superimposed on the page image displayed on the associated user interface 106 so as to facilitate the user selection of a signature area as discussed in greater detail below. The user is then presented with the opportunity to magnify the image displayed on the user interface 106 so as to facilitate the selection of the position of a signature area for incorporation of the retrieved digital signature image. That is, the user is able, via interactions with a graphical user interface displayed on the user interface 106, to zoom in or out on the page image displayed thereon.

The user is then prompted, via the graphical user interface displayed on the user interface 106, to select a signature area via a dragging operation on the page image displayed on the user interface 106. In accordance with one embodiment of the subject application, the user selects a first block on the grid superimposed on the page image at the location where the user desires to designate the signature area. By maintaining contact with the touchscreen and dragging a finger, cursor, or other selection indicator, as will be known in the art, along a series of blocks on the image, the user is able to select a portion of the page image data for insertion of the digital signature image. Following receipt of the user selection of a signature area via the dragging operation referenced above, a signature area is generated on the page image displayed on the user interface 106. The skilled artisan will appreciate that suitable such markings include, for example and without limitation, highlighting the selected blocks, outlining the selected blocks, animations surrounding the selected blocks, or the like. For example, when interaction with the document processing device 104 by the user is with physical contact, upon release of the pressure of a finger on the touchscreen, the signature area is designated on the touchscreen display. Similarly, when user interaction is via another input device, e.g. mouse, ball wheel, touchpad, or the like, upon release of the selection button, the signature area is designated on the display of the user interface 106. The user is then able to reposition the area via dragging the highlighted, shaded, or otherwise distinguished signature area to any suitable portion of the displayed page image.

Once the position of the signature area is deemed acceptable by the associated user, the retrieved signature image data is then superimposed within the signature area by the controller 108 or other suitable component associated with the document processing device 104. That is, the retrieved image of the signature associated with the user is displayed within the selected signature area on the page image as displayed on the graphical user interface associated with the user interface 106. In the event that the user desires to increase or decrease the size of the signature area, the user interacts with the graphical user interface of the touchscreen user interface 106 via dragging operations, whereupon the signature area is increased or decreased to the desired size. It will be appreciated by those skilled in the art that in accordance with one embodiment of the subject application, the superimposed digital signature image is also altered in accordance with the increase or decrease in size of the signature area. For example, when the user enlarges the signature area, the superimposed digital signature is also enlarged in relation to the signature area. Upon selection by the user to continue, e.g. acceptance of the superimposed digital signature on the selected signature area, the document processing device 104 generates a composite document output inclusive of the electronic document data and the signature image data.

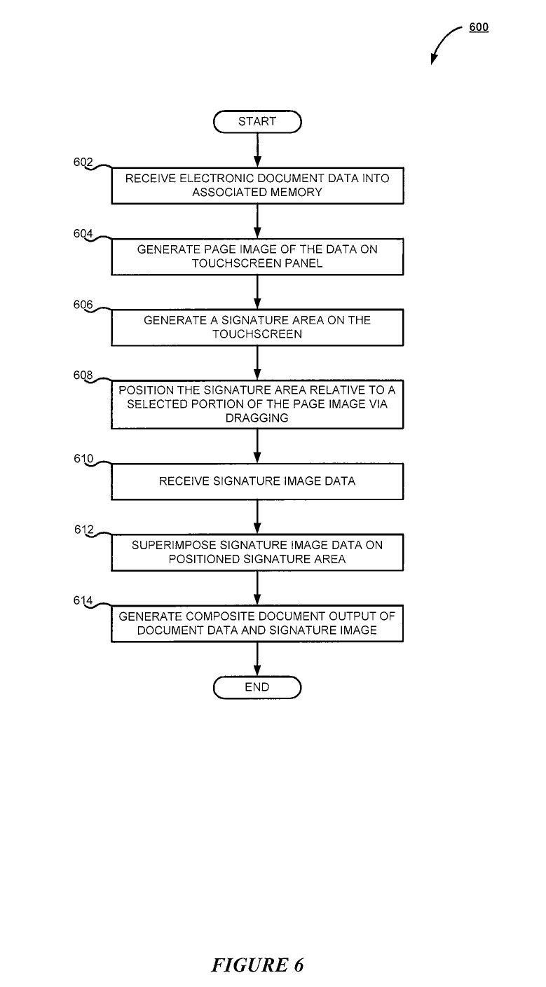

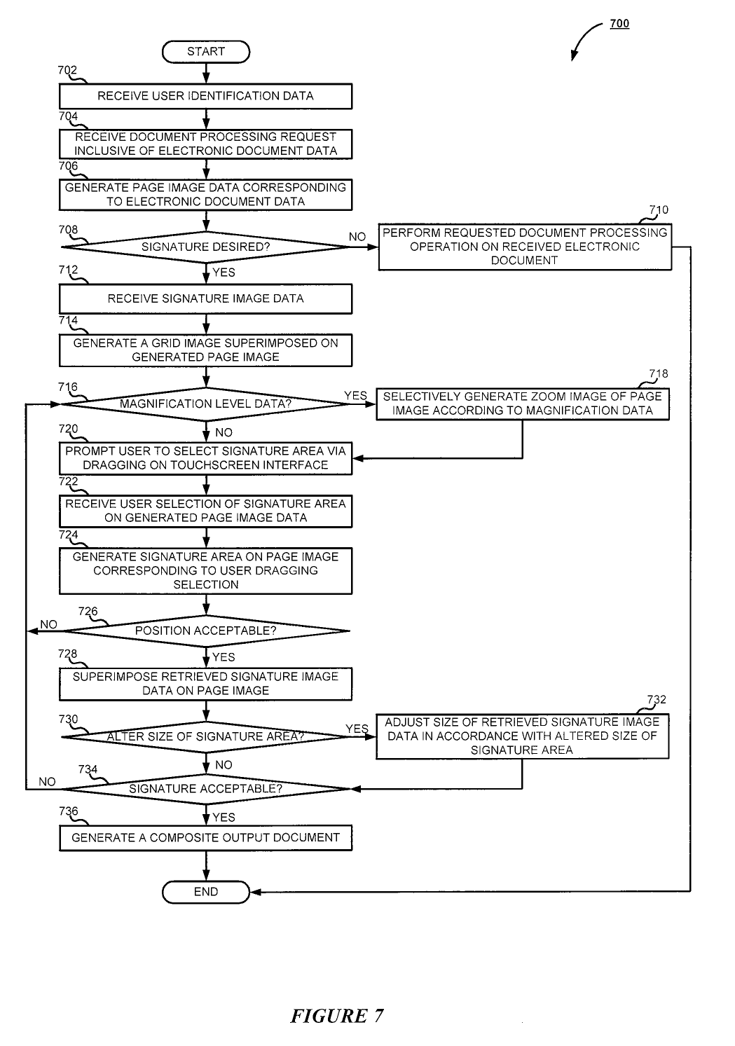

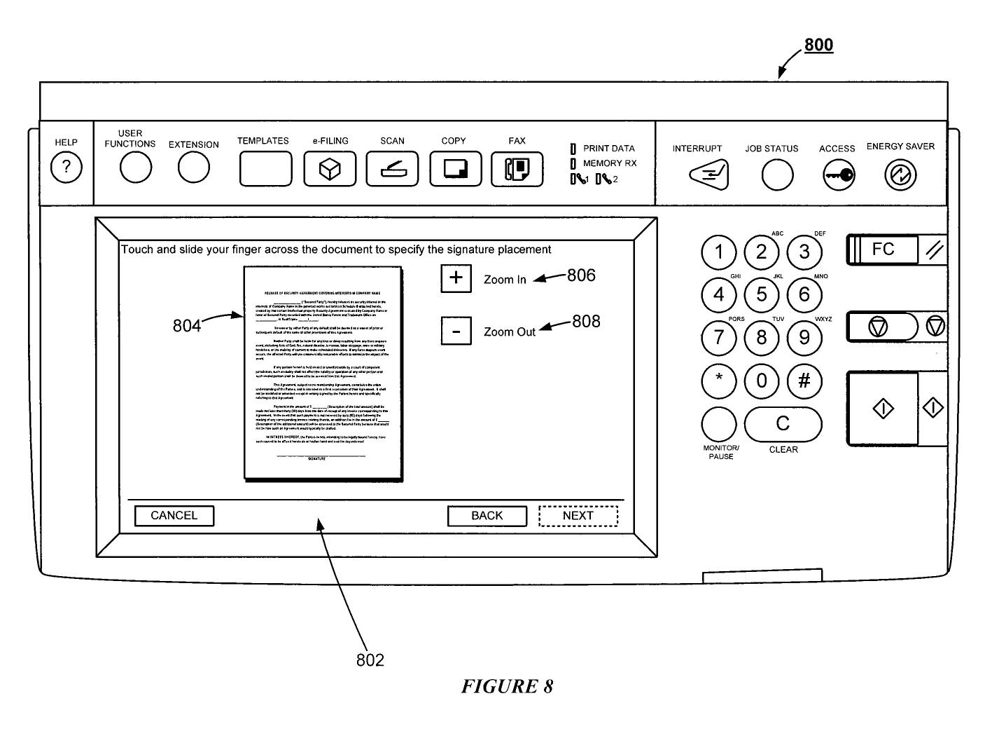

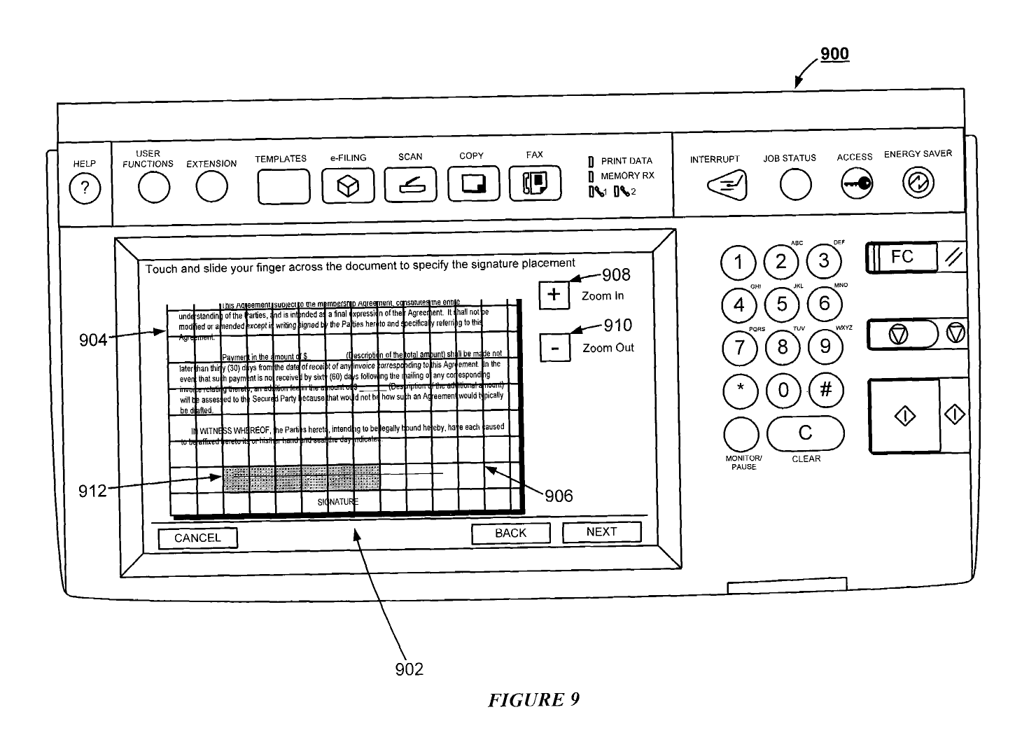

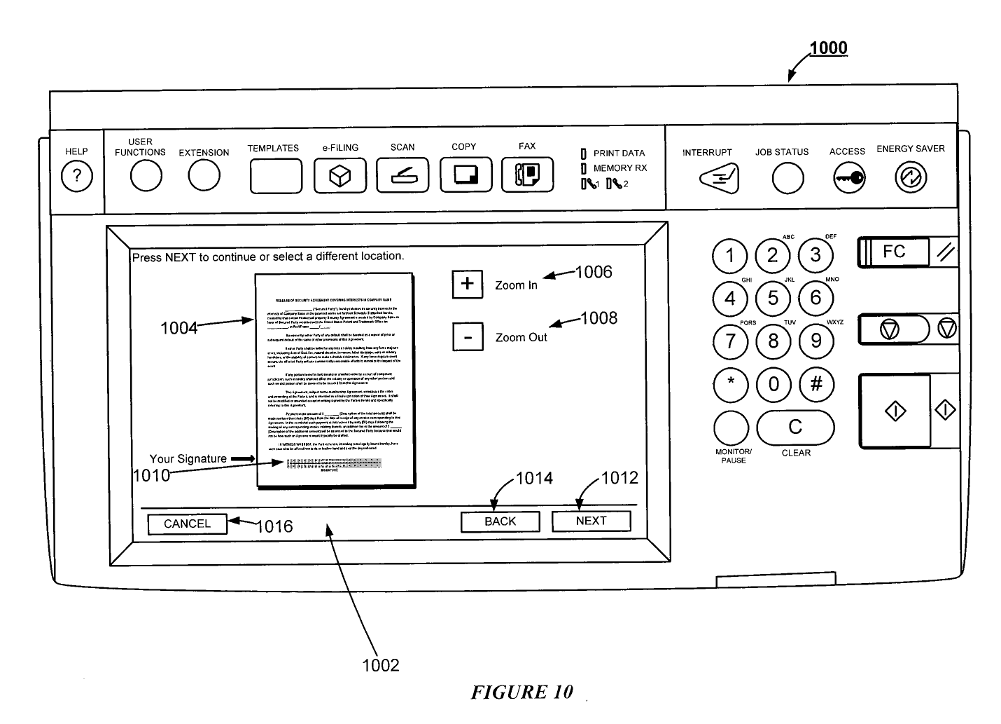

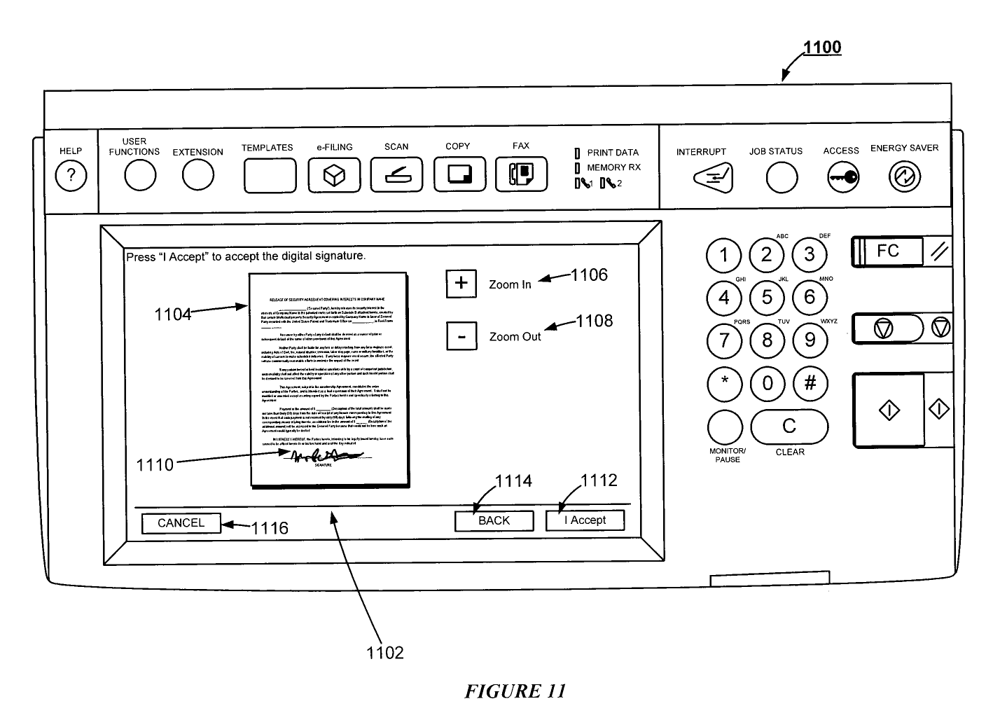

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7, and the example touchscreen interfaces depicted in FIG. 8, FIG. 9, FIG. 10, and FIG. 11. Turning now to FIG. 6, there is shown a flowchart 600 illustrating a method for document watermarking in accordance with one embodiment of the subject application. Beginning at step 602, electronic document data is received into a memory associated with an associated document processing device 104. It will be appreciated by those skilled in the art that the associated memory is capable of comprising system memory, as shown in FIGS. 2 and 4, the associated data storage 110, or the like.

The controller 108 or other suitable component associated with the document processing device 104 then facilitates the generation of page image data on the touchscrecn user interface panel associated with the user interface 106 at step 604. At step 606, a signature area is generated on the touchscreen user interface. In accordance with one embodiment of the subject application, the signature area is generated on a portion of the page image data displayed on the user interface 106 associated with the document processing device 104. The signature area is then positioned, at step 608, relative to a selected portion of the page image data via a dragging interaction with the touchscreen interface panel. For example, the user drags a signature area to a desired portion of the page displayed on the user interface 106.

At step 610, the controller 108 or other suitable component associated with the document processing device 104 receives signature image data corresponding to a signature image. In accordance with one example embodiment of the subject application, the signature image data is stored in the data storage device 110 communicatively coupled to the document processing device 104 and readily accessible thereto. It will be appreciated by those skilled in the art that the signature image data is also capable of being received, for example and without limitation, from a portable storage medium, a scanning output of a hardcopy signature, stylus interaction with the touchscreen, the user device 114, or the like. The signature image data is then superimposed on the positioned signature area at step 612. At step 614, a composite document output is then generated inclusive of the electronic document data and the signature image data, with the signature image being formed in the positioned signature area. Thus, for example and without limitation, the user interface 106 displays a graphical representation, e.g. thumbnail, preview image, etc., of the received electronic document with a digital signature, e.g. the received signature image, overlaid on the document in the position determined by an associated user.

Referring now to FIG. 7, there is shown a flowchart 700 illustrating a method for document watermarking in accordance with one embodiment of the subject application. The methodology depicted in FIG. 7 begins at step 702, whereupon user identification data is received from an associated user via interaction with the user interface 106 associated with the document processing device 104. It will be understood by those skilled in the art that such identification data includes, for example and without limitation, a username, password, biometric data, or the like. A document processing request is then received at step 704 by the document processing device 104 inclusive of at least one electronic document and corresponding document processing instructions, e.g. print, facsimile transmission, electronic mail transmission, copy, scan to storage, or the like.

Page image data is then generated at step 706 by the controller 108 or other suitable component associated with the document processing device 104 via the touchscreen panel of the user interface 106. A suitable template example of such a user interface 106 and associated touchscreen panel, inclusive of a graphical user interface associated therewith, is illustrated in FIG. 8. As shown in FIG. 8, a user interface 800 includes a touchscreen panel 802 on which is displayed a graphical user interface to facilitate interactions between the associated user and the document processing device 104. Page image data 804 corresponding to the received electronic image of the document processing request is also shown on the touchscreen panel 802 of FIG. 8. The user interface 800 of FIG. 8 further displays, via the touchscreen panel 802, a “zoom in” icon 806 and a “zoom out” icon 808, corresponding to user-selectable magnification levels, as will be discussed in greater detail below.

Returning to FIG. 7, following the generation of the page image data 804 at step 706, flow proceeds to step 708, whereupon a determination is made whether the associated user desires to add a signature image, i.e. digitally sign the electronic document. Upon a determination that no signature image is to be added to the electronic document, the document processing device 104 performs the document processing operation requested on the electronic document at step 710, whereupon the methodology illustrated in FIG. 7 terminates. When it is determined at step 708 that a digital signature image is desired, flow proceeds to step 712.

At step 712, signature image data is received corresponding to the associated user. In accordance with one example embodiment of the subject application, the signature data is received from associated memory by the controller 108 or other suitable component associated with the document processing device 104. In such an embodiment, the signature image data is received from the associated data storage device 110 by the controller 108 in accordance with the received user identification data. Stated another way, the data storage device 110 includes a plurality of signature images, each of which is associated with corresponding user identification data associated with a given user. According to another embodiment of the subject application, the signature image is received from the user device 114 via the computer network 102, from a portable storage device, from the user via interactions with the user interface 106, e.g. a stylus or mouse, via a scanning operation by the document processing device 104 on a hardcopy of a user-associated signature, or the like. Following such receipt of signature image data, flow proceeds to step 714, whereupon a grid image is superimposed on the generated page data. Reference is now made to FIG. 9, which illustrates a user interface 900 corresponding to the generation of such grid image superimposed on the page data.

As shown in FIG. 9, the user interface 900 includes a touchscreen panel 902, with page image data 904 displayed corresponding to the received electronic document. Also illustrated in FIG. 9 is the application of the grid image to the page image data 904, designated at 906. It will be apparent to those skilled in the art that the application of the grid image 906 to the page image data 904 results in an overlay of a plurality of blocks on the image data. The relevance of such blocks is described in greater detail below.

Returning to FIG. 7, as illustrated in FIG. 9, following the generation of the grid image 906 on the page image data 904, flow proceeds to step 716, whereupon a determination is made whether magnification level data has been received. That is, whether the user has selected the “zoom in” icon 908 so as to increase the level of magnification or the “zoom out” icon 910 so as to decrease the level of magnification. When the user has selected either icon 908 or 910, flow proceeds to step 718, whereupon a zoom image of the page image data 904 is selectively generated. It will be appreciated by those skilled in the art that the example user interface 900 of FIG. 9 illustrates magnified page image data 904 following a selection by the user of the “zoom in” icon 908. When no magnification level data has been received, or following application of the magnification level data, flow proceeds to step 720.

At step 720, the user is prompted, via the touchscreen panel 902 of the user interface 900 (interface 106 of FIG. 1), to select a signature area via a dragging operation on the touchscreen panel 902. It will be understood by those skilled in the art that such dragging operation corresponds, for example and without limitation, to a user depressing a block of the grid image 906 overlaid on the page image data 904 and maintaining the physical contact while moving the pressure from the selected block across each desired block via a finger, stylus, or the like. Other dragging-type operations include, for example and without limitation, a mouse, touchpad, or the like, wherein a graphical icon, e.g. pointer, is moved across the selected blocks for selection thereof. User selection of the signature area is then received on the generated page image data 904 at step 722. FIG. 9 illustrates such selection, with those selected blocks suitably depicted as the shaded portion 912 of the touchscreen panel 902. In accordance with one example embodiment of the subject application, the user presses a finger down on a block at the start of a signature line of the page image data 904 and drags the finger across each adjacent block covering the signature line until the entire signature line is highlighted, outlined, or otherwise indicated as being selected. The skilled artisan will appreciate that the other suitable selection methods referenced above are also capable of being employed for selection of the signature area including, for example and without limitation, a stylus dragged across the page image data 904, a mouse to box in portions of the grid 906 overlaid on the page image data 904, a roller ball, a touchpad, and the like, as will be known in the art.

A signature area is then generated on the page image data corresponding to the user dragging selection at step 724. FIG. 10 illustrates the resultant signature area 1010 on the page image data 1004 displayed on the touchscreen panel 1002 of the user interface 1000. Thus, the signature area 1010 on the page image data 1004 corresponds to the user selections made via steps 720-724. The user interface 1000 of FIG. 10 also includes a ‘zoom in’ icon 1006, a “zoom out” icon 1008, a “next” icon 1012, a “back” icon 1014, and a “cancel” icon 1016. The skilled artisan will appreciate that the user is able of returning to selection of the signature area, repositioning the signature area, or the like, returning to the previous screen (page area selection), or proceed to the next scene. Thus, a determination is made at step 726, whether or not the position of the signature area 1010 is acceptable. When the position of the signature area 1010 is not acceptable, flow returns to step 716, whereupon the user is able to move the signature area 1010 to a desired portion on the page image data.

When the position of the signature area 1010 is acceptable, flow proceeds to step 728, with the controller 108 or other suitable component associated with the document processing device 104 superimposing the retrieved signature image data on the page image data. FIG. 11 illustrates a suitable example of a user interface 1100 having a touchscreen display 1102, whereupon the page image data 1104 includes a digital signature image 1110 superimposed thereon. A determination is then made at step 730 whether or not the user desires to alter the size of the signature area 1110. That is, the controller 108 or other suitable component associated with the document processing device 104 determines, based upon user interactions with the touchscreen panel 1102, whether or not the user has increased or decreased the signature area 1110. When the controller 108 makes such a determination, flow proceeds to step 732, whereupon the size of the retrieved signature image data is adjusted in size based upon the altered size of the signature area 1110.

When it is determined that no size adjustment has been received, or after completion of the alteration of the signature image in response to changes to the signature area 1110, flow proceeds to step 734. At step 734, a determination is made whether the signature, as displayed via the user interface 1110, is acceptable. That is, whether or not the user has selected the “I Accept” icon 1112 indicating that the appearance of the signature image 1110 on the page image data 1102 is acceptable and to be output by the associated document processing device 104. When the signature is not acceptable, e.g. the user selects the “back” icon 1114, flow returns to step 716, or the “cancel” icon 1116, whereupon the methodology illustrated in FIG. 7 terminates. It will be understood by those skilled in the art that the user is capable of selecting the “zoom in” icon 1106 to view a magnified view of the signature 1110, the “zoom out” icon 1108 to view a smaller version of the signature 1110, or the like. Upon acceptance of the addition of the signature image 1110, flow proceeds from step 734 to step 736. At step 736, the document processing device 104 generates a composite document output inclusive of the received electronic document and the superimposed signature image on the selected signature area in accordance with the received document processing request.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A document watermarking system comprising:
means adapted for receiving electronic document data into a memory associated with an associated document processing device;
means adapted for generating a page image of the electronic document data on a touchscreen user interface panel associated with the document processing device;
means adapted for generating a signature area on the touchscreen user interface;
means adapted for positioning the signature area relative to a selected portion of the page image in accordance with interaction with the touchscreen by dragging the signature area;
means adapted for receiving signature image data corresponding to a signature image;
means adapted for superimposing an image corresponding to received signature image data on a positioned signature area on the touchscreen user interface; and
means adapted for generating a composite document output inclusive of the electronic document data and the signature image data wherein the signature image is formed in the positioned signature area.

2. The system of claim 1 further comprising:
means adapted for altering a size of the signature portion in accordance with interaction with the touchscreen by dragging an edge thereof; and
means adapted for adjusting a size of the received signature image in accordance with an area of the signature area.

3. The system of claim 2 further comprising means adapted for generating a grid image so as to be superimposed on the page image so as to assist in positioning of the signature area via the touchscreen interface.

4. The system of claim 1 wherein the signature area is rectangular and further comprising means adapted for maintaining relative orientation of the signature area and an edge of the generated page image during positioning thereof.

5. The system of claim 1 further comprising:
means adapted for receiving magnification level selection data via the touchscreen user interface; and
means adapted for selectively generating a zoom image of the page image on the touchscreen user interface in accordance with received magnification level selection data.

6. A method for document watermarking comprising the steps of:
receiving electronic document data into a memory associated with an associated document processing device;
generating a page image of the electronic document data on a touchscreen user interface panel associated with the document processing device;
generating a signature area on the touchscreen user interface;
positioning the signature area relative to a selected portion of the page image, in accordance with interaction with the touchscreen, by dragging the signature area;
receiving signature image data corresponding to a signature image;
superimposing an image corresponding to received signature image data on a positioned signature area on the touchscreen user interface; and
generating a composite document output inclusive of the electronic document data and the signature image data, wherein the signature image is formed in the positioned signature area.

7. The method of claim 6 further comprising the steps of:
altering a size of the signature portion in accordance with interaction with the touchscreen by dragging an edge thereof; and
adjusting a size of the received signature image in accordance with an area of the signature area.

8. The method of claim 7 further comprising the step of generating a grid image so as to be superimposed on the page image so as to assist in positioning of the signature area via the touchscreen interface.

9. The method of claim 6 wherein the signature area is rectangular and further comprising the step of maintaining relative orientation of the signature area and an edge of the generated page image during positioning thereof.

10. The method of claim 6 further comprising the steps of:
receiving magnification level selection data via the touchscreen user interface; and
selectively generating a zoom image of the page image on the touchscreen user interface in accordance with received magnification level selection data.
